(19) United States
(12) Patent Application Publication
(10) Pub. No.: US 2010/0296113 A1
(43) Pub. Date: Nov. 25, 2010

(54) IMAGE OUTPUT DEVICE AND COMPUTER READABLE MEDIUM

(75) Inventor: Hideo FUJII, Ebina-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/620,830

(22) Filed: Nov. 18, 2009

(30) Foreign Application Priority Data
May 20, 2009 (JP) 2009-122458

(51) Int. Cl. G06F 15/00

(52) U.S. Cl. 358/1.9; 358/1.15

(57) ABSTRACT

An image output device includes: an image output unit that prints inputted printing data; an acquiring unit that acquires printing data that is not normally printed by the image output unit; a processing condition storage unit that stores processing conditions for each of predetermined data types; an alternative printing data generating unit that identifies portions corresponding to the data types within the printing data acquired by the acquiring unit, generates alternative printing data obtained by processing the printing data of the identified portions according to the processing conditions of the identified portions, which are stored in the processing condition storage unit, and inputs the generated alternative printing data to the image output unit; and a fault data output control unit that outputs, as fault data, the alternative printing data that is not normally printed by the image output unit.

### CROSS-REFERENCE TO RELATED APPLICATIONS

This application is based on and claims priority under 35 USC 119 from Japanese Patent Application No. 2009-122458 filed May 20, 2009.

### BACKGROUND

1. Technical Field

The present invention relates to an image output device and a computer readable medium.

2. Related Art

Conventionally, there has been provided a service where, when there is trouble in printing image quality when a print has been printed with a printer, the user of the printer sends data of the printing result and the like to a maintenance agency that performs maintenance service of that printer and the maintenance agency analyzes the cause of the printing fault on the basis of the data and eliminates the printing fault.

However, when confidential information is included in the print that caused the printing fault, sometimes the user does not wish to send the data of the printing result and the like to the maintenance agency.

### SUMMARY

According to an aspect of the present invention, there is provided an image output device including an image output unit that prints inputted printing data; an acquiring unit that acquires printing data that is not normally printed by the image output unit; a processing condition storage unit that stores processing conditions for each of predetermined data types; an alternative printing data generating unit that identifies portions corresponding to the data types within the printing data acquired by the acquiring unit, generates alternative printing data obtained by processing the printing data of the identified portions according to the processing conditions of the identified portions, which are stored in the processing condition storage unit, and inputs the generated alternative printing data to the image output unit; and a fault data output control unit that outputs, as fault data, the alternative printing data that is not normally printed by the image output unit.

### BRIEF DESCRIPTION OF THE DRAWINGS

An exemplary embodiment of the present invention will be described in detail below with reference to the drawings, wherein:

FIG. 1 is a diagram showing an example of a system configuration of the exemplary embodiment;

FIG. 2 is a block diagram of an image output device 10 pertaining to the exemplary embodiment;

FIG. 3 is a diagram showing an example of processing condition information in the exemplary embodiment;

FIG. 4A is a diagram describing an example of a processing treatment of character data in the exemplary embodiment, FIG. 4B is a diagram describing an example of a processing treatment of graphic data in the exemplary embodiment, and FIG. 4C is a diagram describing an example of a processing treatment of bitmap image data in the exemplary embodiment;

FIG. 5 is a flowchart of the operation of the image output device 10 in the exemplary embodiment;

FIG. 6 is a diagram showing an example of a fault data output confirmation screen in the exemplary embodiment; and

FIG. 7 is a diagram showing an example of a processing level selection screen in a modified embodiment.

### DETAILED DESCRIPTION

An image output device pertaining to an exemplary embodiment of the present invention will be described below with reference to the drawings.

### Exemplary Embodiment

### Configuration

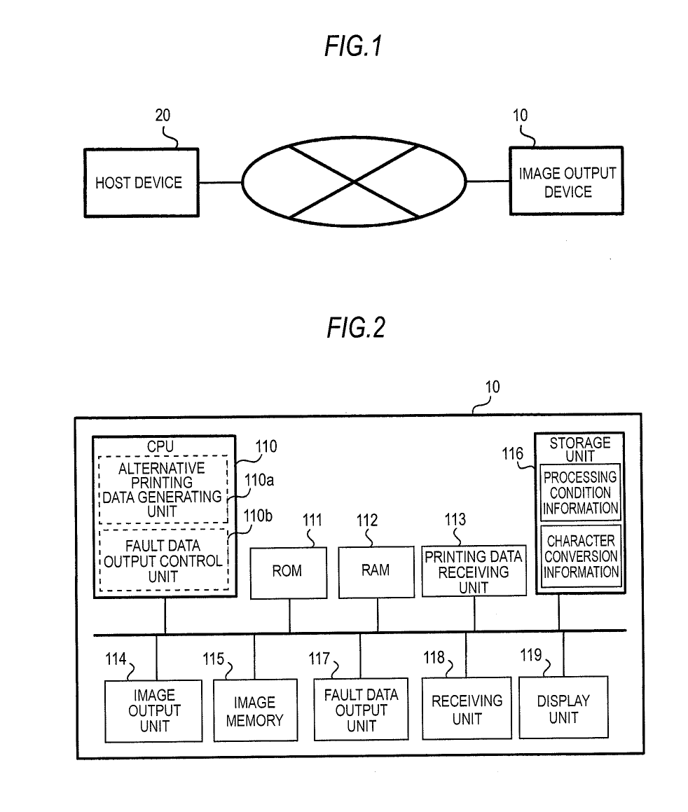

FIG. 1 shows an example of a system configuration pertaining to the present exemplary embodiment. An image output device 10 pertaining to the present exemplary embodiment and a host device 20 are interconnected via communicating means such as a local area network (LAN). The host device 20 is configured by a personal computer or the like, and the user executes various application software installed in the host device 20 to create a document including characters, graphics and images (hereinafter bitmap images) such as photographs. Additionally, when the host device 20 receives from the user an instruction to print the document that has been created, the host device 20 converts data of the document for which printing has been instructed into printing data described by page description language (hereinafter called “PDL”) and transmits the printing data via the communicating means to the image output device 10.

The image output device 10 has a normal mode where the image output device 10 receives the printing data that have been transmitted from the host device 20, analyzes and renders the printing data described by PDL and prints the printing data it has rendered in page units on a recording medium such as paper and a fault data generating mode where, when a printing fault arises, the image output device 10 generates fault data in which recreation of the printing fault is verified on the basis of the printing data. The fault data generating mode is a mode where the image output device 10 converts the printing data causing the printing fault in accordance with processing conditions determined beforehand and outputs the converted printing data as fault data such that the printing fault is recreated.

It will be noted that the printing fault is not a fault resulting from a physical cause such as a paper jam but is a state where printing data are not printed normally, such as, for example, a case where printing data are not printed or a case where a printing result is not outputted as per printing data. In the present exemplary embodiment, the printing fault representing a state where printing data are not printed normally will be described as representing the former case where printing data are not printed.

The details of the image output device 10 pertaining to the present exemplary embodiment will be described below using FIG. 2. FIG. 2 is a block diagram of the image output device 10. As is shown in the drawing, the image output device 10 is configured to include a central processing unit (CPU) 110, a read-only memory (ROM) 111, a random access memory (RAM) 112, a printing data receiving unit 113, an image output unit 114, an image memory 115, a storage unit 116, a fault data output unit 117, a receiving unit 118 and a display unit 119.

The CPU 110 executes a control program stored in the ROM 111 using the RAM 112 as a work area to thereby realize the functions of an alternative printing data generating unit 110a and a fault data output control unit 110b and control the units connected to the CPU 110. It will be noted that a translation program for analyzing PDL and translating PDL into machine language corresponding to the image output device 10 and character conversion information in which characters corresponding to character codes are arranged in the order of character codes are, in addition to the control program, stored in the ROM 111.

That is, the CPU 110 executes the translation program stored in the ROM 111 to translate the printing data described by PDL, render the printing data and convert the printing data into a raster image. Further, the CPU 110 executes, in the fault data generating mode, the function of the alternative printing data generating unit 110a that converts the printing data in accordance with processing conditions corresponding to data types of characters, graphics and bitmap images included in the printing data, generates alternative printing data, sends the alternative printing data to the image output unit 114 and verifies recreation of the printing fault. Further, the CPU 110 executes the function of the fault data output control unit 110b that outputs, as fault data, the alternative printing data in which recreation of the printing fault has been verified to a storage medium connected to the image output device 10 or a server or the like of a maintenance agency of the image output device 10 that is communicably connected to the image output device 10.

The printing data receiving unit 113 is a communication interface for performing communication with the host device 20 and receives the printing data from the host device 20. The image output unit 114 performs image processing such as tone correction with respect to images of the printing data in page units stored in the later-described image memory 115 and performs printing that generates image data of Y (yellow), M (magenta), C (cyan) and K (black), forms toner images of each color of YMCK in accordance with image data by an electrophotographic system and transfers and outputs the toner images to a recording medium. Further, the image output unit 114 outputs to the CPU 110 information indicating whether or not printing has ended normally after printing.

The image memory 115 stores, per page, the raster image data into which the printing data have been rendered. The storage unit 116 is a storage medium such as a hard disk, and processing condition information and the like when the CPU 110 generates the alternative printing data is stored in the storage unit 116. The fault data output unit 117 has an interface that connects an external storage medium such as a universal serial bus (USB) or a memory card and a communication interface that connects to an external device such as the server device of the maintenance agency and outputs the sent fault data to the external storage medium or the external device under the control of the CPU 110.

The receiving unit 118 is equipped with an operation panel that includes various keys for operating the image output device 10, such as a numerical keypad and arrow keys, receives various operations from the user and sends information representing the various operations it has received to the CPU 110. The display unit 119 has a display device such as a liquid crystal display and displays menu screens and various message screens for operating the image output device 10 under the control of the CPU 110.

### <Data>

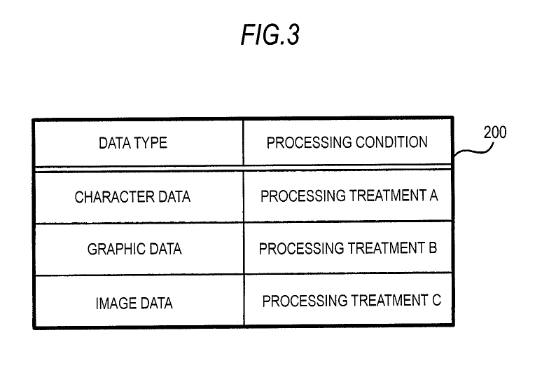

Next, the data stored in the storage unit 116 of the image output device 10 will be described. FIG. 3 shows an example of processing condition information that is referenced when the CPU 110 generates the alternative printing data. As shown in FIG. 3, in processing condition information 200, processing conditions are correlated per data type. The processing conditions are information representing programs in which established algorithms are described in regard to processing treatments of data of each data type.

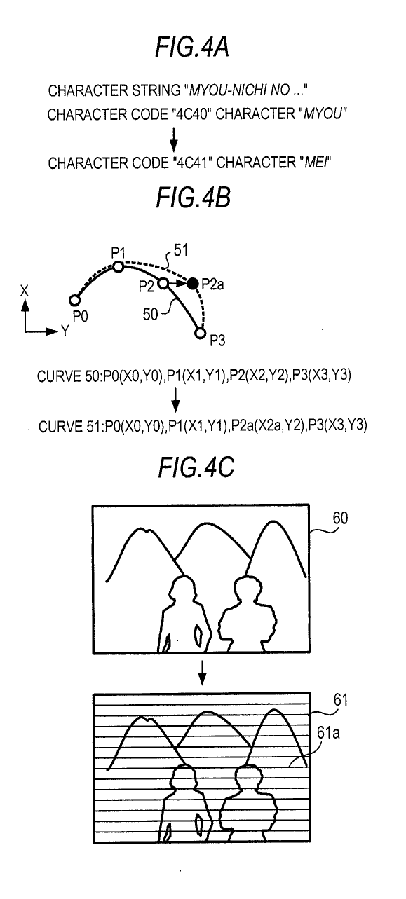

In this example, when the data type is character data, the CPU 110 executes the program of processing treatment A to convert the character data within the printing data. As an example of processing treatment A, for example, as shown in FIG. 4A, when the character string “myou-nichi no . . . ” is included within the printing data and character codes representing each of these characters and parameters such as font and color are included in the printing data described by PDL, the CPU 110 converts, on the basis of the character conversion information stored in the ROM 111, the character codes representing the characters into character codes that differ from the character codes before conversion, such as converting the character code “4C40” that represents the character “myon” into the character code “4C41” that represents the character “mei” and comes next after the character code “4C40”. It will be noted that plural processing conditions for converting the character codes may also be set in processing treatment A, such as a processing condition where the CPU 110 first converts parts of the character string within the printing data, such as, for example, converting the character codes every other character, and a processing condition that converts the character codes of all character data if the printing fault cannot be recreated with the alternative printing data that have been processed by that processing condition.

For example, the processing treatment A may be set as follows. There is exemplified a case in which character string “Today” is included within the printing data, and character codes representing each of these characters and parameters such as font and color are included in the printing data described by PDL. The CPU 110 converts, on the basis of the character conversion information stored in the ROM 111, the character codes representing the characters into character codes that differ from the character codes before conversion, such as converting the character codes representing the characters “Today”, for example, 546F646179 in ASCII code into characters “Upebz corresponding to the character codes 557065627A having the respective character codes shifted one by one. The character codes 546F646179 representing the characters “Today” are expressed by putting 54, 6F, 64, 61, and 79 together, which are codes representing T, o, d, a, and y being the respective characters of “Today”. The respective character codes are shifted one by one to result in 55, 70, 65, 62, and 7A, which are replaced with corresponding characters to result in “Upebz”. In this case, the character codes may be converted into a meaningless coined word such as the characters “Upebz”.

In this manner, in the character data processing treatment exemplified above, just the character codes of the character string are converted without attributes such as the length, font and color of the character string being converted, so that it is difficult for the content of the original printing data to be recognized even if the character data after conversion flow out.

Next, when the data type is graphic data, the CPU 110 executes the program of processing treatment B to convert the coordinates of the graphic data within the printing data in accordance with a coordinate conversion condition determined beforehand. For example, when point coordinates, a function and attribute information such as line type, line width and color are included as parameters representing a Bezier curve in the printing data described by PDL, the CPU 110 determines, as shown in FIG. 4B, a solid Bezier curve 50 that has been computed on the basis of the point coordinates and the function within the original printing data. Then, the CPU 110 converts, for example, the X coordinate of a randomly selected point P2 (X2, Y2) of the points (P0 to P3) on the Bezier curve 50 into point P2a (X2a, Y2) in accordance with the coordinate conversion condition, such as increasing or reducing the coordinate by a value determined beforehand, and converts the original Bezier curve 50 into a dashed curve 51 that passes through the converted point P2a.

It will be noted that, in the example above, the CPU 110 has been described as performing processing treatment B using a Bezier curve, but the CPU 110 may also be configured to perform the same processing treatment as described above with respect to various graphics other than this or may be configured to administer a processing treatment in accordance with types of graphics. Further, plural processing conditions may be set in processing treatment B, such as converting some or all of the coordinates on a graphic in accordance with the coordinate conversion condition.

In this manner, by converting just the coordinates that represent the graphic data included in the printing data, a graphic that is different from the original graphic is drawn in a state where attributes such as line type, line width and color of the original graphic data are maintained.

Next, processing treatment C, when the data type is bitmap image data, will be described. In processing treatment C, there are set processing conditions such as, in order to recreate a printing fault resulting from a buffer overflow, the CPU 110 adding, to the original bitmap image data, image data determined beforehand, or the CPU 110 converting the original bitmap image data into image data determined beforehand, such that the data amount when the CPU 110 has rendered the bitmap image data within the printing data is not reduced.

For example, in the present exemplary embodiment, as shown in FIG. 4C, a composite bitmap image 61 obtained by superimposing a mosaic image 61a determined beforehand onto a bitmap image 60 before conversion is generated by processing treatment C. It will be noted that, when the CPU 110 converts the bitmap image data, there may also be set a processing condition such as the CPU 110 converting the original bitmap image data into other image data so as to not convert attribute information such as the color space of the bitmap image data before conversion in a state where the CPU 110 maintains the data amount at the time of rendering. In this manner, by converting the original bitmap image data without reducing the memory amount when the CPU 110 has rendered the original bitmap image data, it becomes easier to perform verification of recreation of a printing fault resulting from a buffer overflow, and confidential information such as a person included in the original bitmap image data is concealed.

### <Operation>

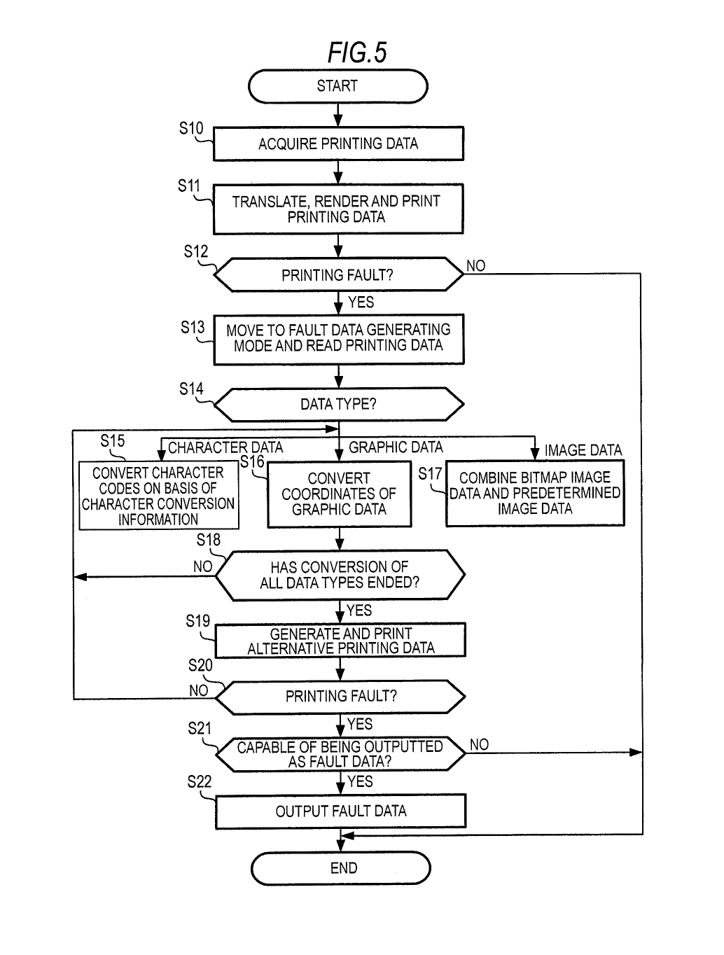

Next, the operation of the image output device 10 pertaining to the present exemplary embodiment will be described. FIG. 5 is a flowchart of the operation of the image output device 10. In step S10, the CPU 110 of the image output device 10 acquires, in page units, the printing data described by PDL via the printing data receiving unit 113 from the host device 20 and stores the printing data in the RAM 112. Then, the CPU 110 executes the translation program stored in the ROM 111, translates and renders the printing data stored in the RAM 112, and sequentially sends the raster image data it has rendered to the image memory 115. Then, the raster image data that have been sent to the image memory 115 are sequentially read and printed by the image output unit 114 (step S11). It will be noted that, in the present exemplary embodiment, the CPU 110 stores, in the RAM 112 in page units, printing data of an intermediate language obtained by translating the printing data described by PDL and erases the printing data from the RAM 112 when the printing data have been printed normally.

The CPU 110 ends processing when it receives information indicating that printing has been performed normally by the image output unit 114 (step S12: NO), that is, when the printing data are printed and no printing fault has arisen. Further, when the CPU 110 receives information indicating that the printing data were not printed by the image output unit 14 and that printing did not end normally and receives information of the printing data that caused a printing fault (step S12: YES), the CPU 110 moves from the normal mode to the fault data generating mode, reads from the RAM 112 the translated printing data corresponding to the printing data that caused the printing fault (step S13), and performs processing treatments in accordance with the data types of the data included in the printing data (step S14).

In step S14, with respect to data whose data type is character data, the CPU 110 reads the processing condition information 200 from the storage unit 116 and executes the program of processing treatment A corresponding to character data. That is, the CPU 110 references the character conversion information stored in the ROM 111 and converts the character codes within the printing data into other character codes in accordance with the processing condition for converting character codes determined beforehand (step S15).

In step S14, with respect to data whose data type is graphic data, the CPU 110 executes the program of processing treatment B corresponding to graphic data on the basis of the processing condition information 200. That is, the CPU 110 converts, in accordance with the processing condition for converting coordinates determined beforehand, the coordinates on the graphics determined on the basis of the parameters and the functions representing each graphic (step S16).

Further, in step S14, with respect to data whose data type is bitmap image data, the CPU 110 executes the program of processing condition C corresponding to bitmap image data on the basis of the processing condition information 200. That is, the CPU 110 combines the bitmap image data within the printing data and the image data determined beforehand to convert the original bitmap image data in accordance with the processing condition determined beforehand by which the CPU 110 converts image data (step S17).

When the CPU 110 has performed the processing treatments of steps S15 to S17 in regard to one page of printing data (step S18: YES), the CPU 110 combines the data that have been converted by the processing treatments, generates one page of alternative printing data, sends the one page of alternative printing data to the image memory 115, and performs printing with the image output unit 114 (step S19). It will be noted that the CPU 110 repeatedly performs the processing treatments of steps S15 to S17 until the conversion treatments of steps S15 to S17 are performed in regard to one page of printing data (step S18: NO).

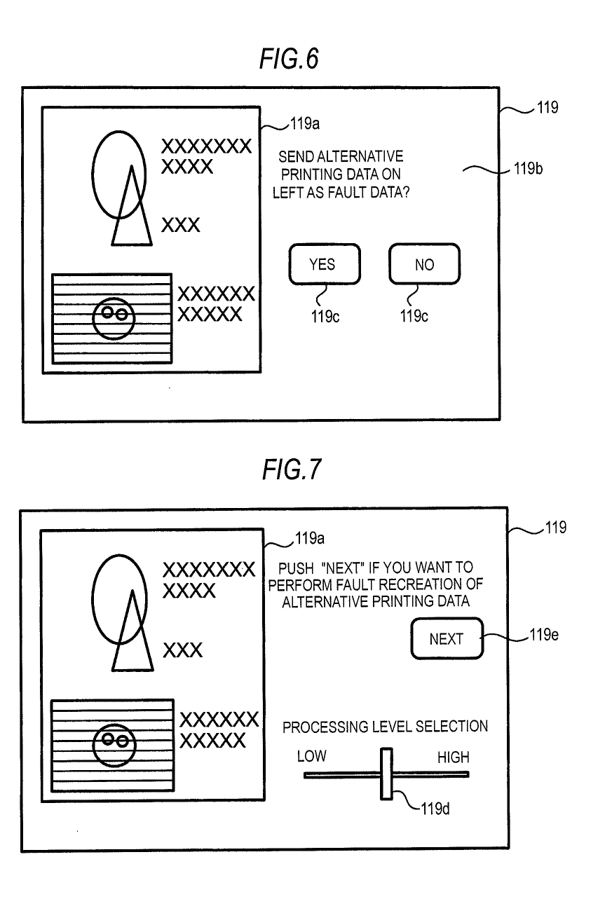

When the CPU 110 receives information indicating that the alternative printing data stored in the image memory 115 have been printed normally by the image output unit 114 (step S20: NO), the CPU 110 returns to step S14 and performs processing treatments corresponding to each data type. Further, when the CPU 110 receives information indicating that the alternative printing data have not been printed normally (step S20: YES), the CPU 110 displays on the display unit 119, as shown in FIG. 6, a fault data output confirmation screen that includes a raster image 119a of the alternative printing data, a message 119b asking whether or not the user wants to output the alternative printing data as fault data and selection buttons 119c for the user to select whether or not to output the alternative printing data as fault data, and the CPU 110 receives, from the user, an operation that selects whether or not to output the alternative printing data (step S21).

When the user performs, via the receiving unit 118, a selection operation to output the alternative printing data as fault data (step S21: YES), the CPU 110 sends the alternative printing data to the fault data output unit 117 and outputs the alternative printing data as fault data to a storage medium or an external device connected to the fault data output unit 117 (step S22). Further, when the user performs, via the receiving unit 118, a selection operation to not output the alternative printing data as fault data (step S21: NO), the CPU 110 erases the alternative printing data from the image memory 115 and ends processing.

In the present exemplary embodiment, an example has been described where the CPU 110 processes the printing data in accordance with the data types, generates the alternative printing data and verifies recreation of a printing fault. Thus, even when a printing fault in a case where printing data are not printed occurs and fault data are sent to a maintenance agency, the content of the original printing data is concealed and the cause of the printing fault is analyzed by the maintenance agency using the fault data.

### Modifications

Modifications of the present invention will be described below.

(1) In the preceding exemplary embodiment, an example has been described where the image output device 10 performs processing treatments per data type in regard to the data types within the printing data in accordance with the processing conditions determined beforehand, generates the alternative printing data and verifies recreation of a printing fault, but the image output device 10 may also be configured such that the user selects the processing level of the printing data and the image output device 10 generates the alternative printing data in accordance with the processing condition corresponding to the selected processing level.

For example, in this case, when printing in the normal mode did not end normally, the CPU 110 displays on the display unit 119 the processing level selection screen shown in FIG. 7. In the example of FIG. 7, the CPU 110 converts the image of the original printing data into an image that becomes more different the more that the processing level becomes closer to “high”. Data types that become processing targets, ranges of data to be processed and processing conditions whose processing content is determined are set in accordance with the processing level, such as, for example, setting a processing condition by which the CPU 110 performs a processing treatment determined beforehand in regard to all data of all data types when the processing level is “high” and setting a processing condition by which the CPU 110 performs a processing treatment in regard to some data whose data type is character data when the processing level is “low”. In the example of FIG. 7, when the user moves, via the receiving unit 118, an operator 119d shown in FIG. 7 that selects the processing level, the CPU 110 converts the printing data in accordance with the processing condition corresponding to the processing level represented by the position of the operator 119d and displays the raster image 119a of the converted alternative printing data in the same manner as in the exemplary embodiment. Additionally, when a “next” button 119b instructing verification of recreation of fault data with the displayed raster image 119a is selected by the user, the CPU 110 sends the alternative printing data to the image memory 115 in the same manner as in the exemplary embodiment to try to recreate the printing fault. It will be noted that, when the printing fault is not recreated, the CPU 110 again displays the processing level selection screen of FIG. 7, the user selects the processing level in the same manner as described above, and the CPU 110 repeatedly performs generation of the alternative printing data and verification of recreation of the printing fault until the printing fault is recreated.

(2) In the preceding exemplary embodiment, an example has been described where the CPU 110 applies the processing conditions with respect to all data types, but the CPU 110 may also be configured to set a data type priority order in which to perform the processing treatments beforehand, combine data that have been treated in the priority order with other data, generate the alternative printing data, and perform recreation of the printing fault. For example, when the CPU 110 sets the priority order of the processing treatments to the order of character data→bitmap image data→graphic data, first, the CPU 110 converts the character data within the printing data in accordance with the processing condition corresponding to character data, combines the converted character data and another data type, that is, the unprocessed bitmap image data and the graphic data included in the printing data, and generates first alternative printing data. Then, the CPU 110 uses the first alternative printing data to perform printing with the image output unit 114 to try to recreate the printing fault. When the printing fault is recreated, the CPU 110 outputs the first alternative printing data as fault data, and when the printing fault is not recreated, the CPU 110 processes the data in accordance with the processing conditions of the character data and the bitmap image data, combines the processed character data with bitmap image data and the unprocessed graphic data within the printing data, and generates second alternative printing data. Then, the CPU 110 uses the second alternative printing data to try to recreate the printing fault, and when the printing fault is recreated with the second alternative printing data, the CPU 110 outputs the second alternative printing data as fault data, and when the printing fault is not recreated, the CPU 110 performs the processing treatment in regard also to the graphic data in addition to the character data and the bitmap image data, generates third alternative printing data, and verifies recreation of the printing fault in regard to the third alternative printing data.

(3) In the preceding exemplary embodiment, an example has been described where the fault data are sequentially outputted to a storage medium connected to the image output device 10 or to an external device or external storage medium communicably connected to the image output device 10, but the CPU 110 may also be configured to store the fault data in the storage unit 116 of the image output device 10 and output, with respect to an external device, the fault data stored in the storage unit 116 in time period units determined beforehand or in units of numbers of fault data determined beforehand.

(4) In the preceding exemplary embodiment, an example has been described where, when a printing fault in a case where printing data are not outputted arises, the image output device 10 moves to the fault data generating mode and performs generation of the alternative printing data and verification of the printing fault, but the image output device 10 may also be configured such that, when a printing fault arises, the image output device 10 receives an instruction to generate the fault data and moves to the fault data generating mode. In this case, information representing printing data that caused the printing fault and a switch or the like instructing generation of fault data in regard to the printing data are set beforehand in the receiving unit 118 of the image output device 10. Then, when operation of the switch is performed by the user, the CPU 110 reads the instructed printing data from the RAM 112 and performs generation of the alternative printing data and verification of the printing fault in the same manner as in the exemplary embodiment.

(5) In the preceding exemplary embodiment, a printing fault when printing data are not outputted has been described as an example of a state where printing was not performed normally, but the image output device 10 may also be configured such that, in the case of a printing fault when a printing result was not outputted as per printing data, when the user confirms the printing result, the user performs an operation instructing generation of fault data in the same manner as in modification (4) such that the image output device 10 is moved to the fault data generating mode.

(6) In the preceding exemplary embodiment, an example has been described where the CPU 110 applies processing conditions with respect to all data types within the printing data, but the CPU 110 may also be configured such that the user can designate data types whose printing data are to be processed. In this case, the CPU 110 is configured to display on the display unit 119 a selection screen that allows the user to select the data type whose printing data are to be processed in the fault data generating mode, read from the storage unit 116 the processing condition corresponding to the data type that has been selected by the user, apply that processing condition to the printing data, and generate the alternative printing data.

(7) In the preceding exemplary embodiment, an example has been described where the CPU 110 stores in the RAM 112 the printing data where printing data described by PDL have been translated and uses the translated printing data in the fault data generating mode until printing is ended normally, but the CPU 110 may also be configured to store in the RAM 112 the printing data described by PDL before translation, again read the printing data stored in the RAM 112 and use the translation program to translate the printing data in the fault data generating mode.

(8) The program that is executed by the CPU 110 in the exemplary embodiment can be provided in a state where it has been stored in a computer-readable recording medium such as a magnetic recording medium (magnetic tape, magnetic disk, etc.), an optical recording medium (an optical disk, etc.), a magneto-optical recording medium or a semiconductor memory. Further, it is also possible to allow the image output device 10 to download the program using communicating means such as the Internet.

What is claimed is:

1. An image output device, comprising:
an image output unit that prints inputted printing data;
an acquiring unit that acquires printing data that is not normally printed by the image output unit;
a processing condition storage unit that stores processing conditions for each of predetermined data types;
an alternative printing data generating unit that identifies portions corresponding to the data types within the printing data acquired by the acquiring unit, generates alternative printing data obtained by processing the printing data of the identified portions according to the processing conditions of the identified portions, which are stored in the processing condition storage unit, and inputs the generated alternative printing data to the image output unit; and
a fault data output control unit that outputs, as fault data, the alternative printing data that is not normally printed by the image output unit.

2. The image output device according to claim 1, wherein the processing conditions include a condition where, when the data type is characters, character codes representing the characters within the printing data are converted into different character codes, a condition where, when the data type is graphics, coordinate positions representing the graphics within the printing data are converted into different coordinate positions, and a condition where, when the data type is images, the images are converted so as to not reduce the data amount when printing the images within the printing data, and
wherein the alternative printing data generating unit processes the portions corresponding to the data types of the printing data according to the processing conditions corresponding to the data types and combines the printing data of the processed portions to generate the alternative printing data.

3. The image output device according to claim 2, wherein the processing condition storage unit stores a priority order that applies the processing conditions of the data types to the printing data, and
wherein the alternative printing data generating unit applies the processing conditions to the printing data according to the priority order, generates the alternative printing data and, when the generated alternative printing data is not normally printed by the image output unit, applies the applied processing condition and the processing condition that follows the applied processing condition to the printing data to generate new alternative printing data.

4. The image output device according to claim 2, wherein the processing condition storage unit stores the processing conditions for each of processing levels representing a degree of processing of the printing data,
wherein the image output device further comprises a receiving unit that receives designation of the processing level, and
wherein the alternative printing data generating unit generates the alternative printing data based on the processing conditions corresponding to the processing level that is received by the receiving unit, which are stored in the processing condition storage unit.

5. A computer readable medium storing a program causing a computer equipped with an image output unit that prints inputted printing data and a processing condition storage unit that stores processing conditions for each of predetermined data types to execute a process for outputting an image, the process comprising:
acquiring printing data that is not normally printed by the image output unit;
identifying portions corresponding to the data types within the acquired printing data, generating alternative printing data obtained by processing the printing data of the identified portions according to the processing conditions of the identified portions, which are stored in the processing condition storage unit, and inputting the alternative printing data to the image output unit; and
outputting, as fault data, the alternative printing data that is not normally performed by the image output unit.
